(19) United States
(12) Patent Application Publication
(10) Pub. No.: US 2008/0290065 A1
(43) Pub. Date: Nov. 27, 2008

(54) Laser Ice Etching System and Method

(75) Inventors: Michael T. Jennison, Cranberry Township, PA (US); Jeffrey Gibala, North Huntingdon, PA (US)

Correspondence Address: THE WEBB LAW FIRM, P.C., 700 KOPPERS BUILDING, 436 SEVENTH AVENUE, PITTSBURGH, PA, 15219, US

(73) Assignee: CK SMART, LLC, Cranberry Township, PA (US)

(21) Appl. No.: 11/915,471

(22) PCT Filed: May 24, 2006
(86) PCT No.: PCT/US06/20176

§ 371 Date: Jun. 30, 2008

Related U.S. Application Data
(60) Provisional application No. 60/684,827, filed on May 25, 2005.

(51) Int. Cl. B44C 1/22; H01S 3/22; H01S 3/02

(52) U.S. Cl. 216/28; 372/57; 372/38.02

(57) ABSTRACT

A laser ice etching system (7) includes a laser (11) for producing a laser beam, a laser aiming system (13) adapted to aim and direct a laser beam produced by the laser (11) onto forming ice cubes and a controller (9) operatively coupled to the laser (11) and the laser aiming system (13). The controller (9) provides commands to the laser (11) to produce the laser beam and commands to the laser aiming system (13) to aim and direct the laser beam onto the forming ice cubes. The laser ice etching system (7) is positioned adjacent to a vertical cold plate (3) of an ice making machine (1) and forms an image in the center of an ice cube by aiming and directing the laser beam in a predetermined pattern over a portion of the ice cube.

### CROSS REFERENCE TO RELATED APPLICATIONS

This application claims the benefit of U.S. Provisional Patent Application No. 60/684,827 entitled “Laser Ice Etching System and Method” filed May 25, 2005, which is hereby incorporated by reference in its entirety.

### BACKGROUND OF THE INVENTION

1. Field of the Invention

The present invention relates, in general, to a system and method for producing ice cubes and, more particularly, to a system and method for laser etching an image within an ice cube.

2. Description of Related Art

Currently, there are various types of commercial ice machines that make various types of ice. Each type of ice has common applications. For example, flake ice may be used in salad bars, seafood factories, and hospitals while traditional rectangular cube ice has other applications in restaurants, etc. Today, the ice used by restaurants in drinks is a style which is typically semi-flat on one side and either round or rectangular with a symmetrically raised opposite side. Different manufacturers have different names for their particular shape (“crescent cube”, “moon cube”, “contour cubes”, among others). In almost all cases the machines that make this type of ice use a very similar process. An ice making machine 1 for performing the ice making process is shown in FIGS. 1 and 2. Ice making machine 1 includes a vertical cold plate 3 within ice making machine 1 that has the negative mold shape of a large matrix of cubes. Ice making machine 1 functions as follows. First, vertical cold plate 3 is cooled. Then water flows from the top down across vertical cold plate 3 and small layers of water freeze as they flow across vertical cold plate 3, gradually forming ice cubes 5. When ice cubes 5 are fully formed, ice making machine 1 begins a “harvest cycle”. During this process, vertical cold plate 3 is heated slightly causing a thin layer of ice to melt and ice cubes 5 to fall off into a bin (not shown) below. Ice cubes 5 formed using such an ice making machine 1 and process are generally very clear, free of most impurities and perfect for drinks.

Methods for incorporating an image or design within an ice cube are known in the art. For instance, U.S. Pat. No. 6,062,036 describes an apparatus and method for producing an ice cube with a visible motif/relief by joining two ice cubes together to form a single ice cube. One of the ice cubes has a depression that encloses a pocket of air when formed with the second ice cube, thereby creating a visible design in the center of the ice cube. However, this system requires a device for forming the ice cubes that is completely different and independent from existing ice machines. Furthermore, since the visible motif is formed in the ice cube by trapping a pocket of air within the cube, the design is limited to low-resolution images such as shapes or letters.

A second method of forming a design within an ice cube is disclosed in U.S. Pat. No. 4,990,169. This reference discusses an apparatus and method for producing an ice product bearing a clearly discernable pattern or design caused by the controlled formation of cloudy ice within an otherwise clear ice cube. The resolution of the pattern or design formed with this method is of high quality, and, therefore, the pattern can be virtually any graphic image including letters, numbers, words, messages, pictures, or logos. While this reference discloses a system with the ability to form a high-resolution image within an ice cube, the system can not be easily and inexpensively incorporated into an existing commercial ice machine. Furthermore, neither of these prior art references describes a system or method that uses a laser to etch an image into an ice cube.

Accordingly, a need exists for a device for forming a high-resolution image using a laser etching technique within an ice cube that can be easily and inexpensively incorporated into existing ice commercial ice machines.

### SUMMARY OF THE INVENTION

The present invention is directed to a laser ice etching system. The system includes a laser for producing a laser beam, a laser aiming system adapted to aim and direct a laser beam produced by the laser onto forming ice cubes and a controller operatively coupled to the laser and the laser aiming system. The controller provides commands to the laser to produce the laser beam and commands to the laser aiming system to aim and direct the laser beam onto the forming ice cubes. The laser ice etching system is positioned adjacent to a vertical cold plate of an ice making machine and forms an image in the center of an ice cube by aiming and directing the laser beam in a predetermined pattern over a portion of the ice cube.

The laser ice etching system may further include user interface operatively coupled to the controller and adapted to provide input from a user to the controller. The user interface may be a USB port, a wireless network device, a CD-ROM drive or any combination thereof. The input from the user may be a programmed design.

The laser ice etching system may also further include a lens positioned to focus the laser beam onto the vertical cold plate of the ice making machine. The laser aiming system may include a first mirror operatively coupled to a first drive device and a second mirror operatively coupled to a second drive device. The first and second drive devices may be stepper motors or servo-galvanometers.

The laser is one of a CO₂ laser and an Er:YAG laser. The design is formed within the ice cube due to the occurrence of explosive vaporization when the laser beam contacts the ice cube causing the ice to change immediately to vapor thereby creating a white mark on the ice cube.

The present invention is also a method of laser etching an ice cube. The method includes the steps of forming a plurality of ice cubes on a vertical cold plate of an ice making machine by providing a stream of water across the vertical cold plate, temporarily suspending the stream of water across the vertical cold plate thereby stopping formation of the plurality of ice cubes, aiming and directing a laser beam towards the vertical cold plate to sequentially etch each of the plurality of ice cubes with at least one programmed design to produce an etched image on each of the plurality ice cube and continuing the stream of water across the vertical cold plate thereby resuming formation of the ice cube.

The present invention is further directed to an ice cube formed pursuant to the previously described method.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. As used in the specification and the claims, the singular form of “a”, “an”, and “the” include plural referents unless the context clearly dictates otherwise.

### BRIEF DESCRIPTION OF THE DRAWINGS

FIG. 1 is a perspective view of a conventional commercial ice making machine;

FIG. 2 is a portion of a view of the conventional commercial ice making machine enlarged for magnification purposes;

FIG. 3 is a block diagram of a laser ice etching system in accordance with the present invention;

FIG. 4 is a block diagram of the laser ice etching system of the present invention shown positioned adjacent to the vertical cold plate of an ice making machine;

FIG. 5 is a chart illustrating the absorption of H₂O ice versus the wavelength of a laser;

FIG. 6 is a diagram showing the correspondence between the type of laser and its wavelength;

FIG. 7 is a perspective view of a laser aiming system utilized by the laser ice etching system in accordance with the present invention;

FIG. 8 is an illustration of a pixel count and bitmap image versus spot size produced by the laser etching method of the present invention;

FIG. 9 is a perspective view of several ice cubes with images laser etched therein in accordance with the present invention; and

FIG. 10 is a flow diagram of a method of laser etching an ice cube in accordance with the present invention.

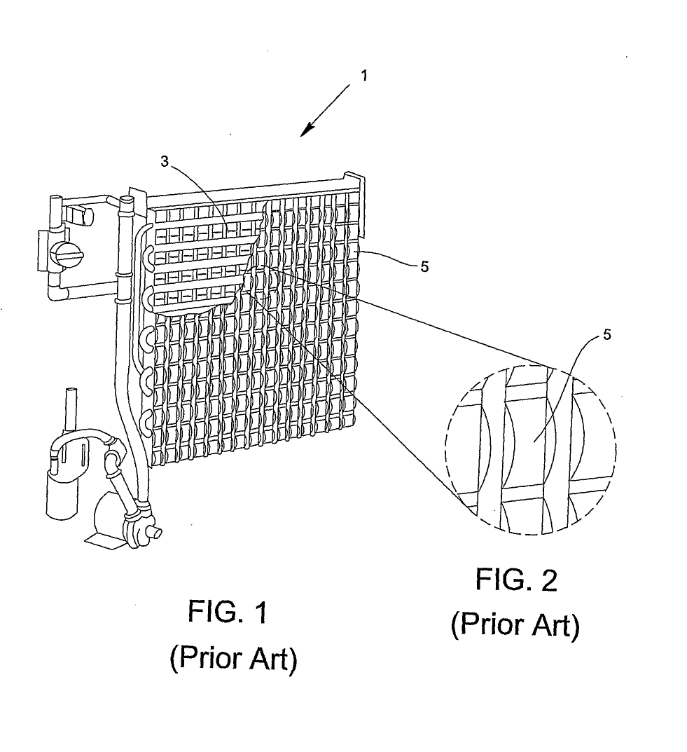

### DETAILED DESCRIPTION OF THE PRESENT INVENTION

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

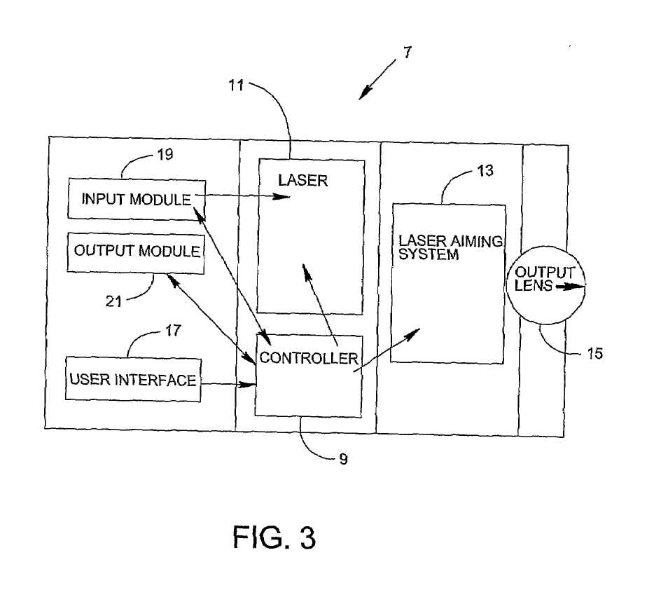

With reference to FIG. 3, a laser ice etching system 7 includes a controller 9 operatively coupled to a laser 11 and a laser aiming system 13. System 7 also includes an output lens 15. Laser aiming system 13, upon command from controller 9, aims and directs a laser beam formed by laser 11 to enable the laser etching of ice cubes while the cubes are being formed on the vertical cold plate of a commercial ice machine. Output lens 15 is provided to focus the laser beam allowing system 7 to accurately etch an image into the ice cube. Controller 9 is also operatively coupled to a user interface 17, an input module 19 and an output module 21. Input module 19 and output module 21 interface laser ice etching system 7 with a variety of inputs and outputs. Such inputs and outputs include, but are not limited to, power requirements, coolant flow for the laser and relay interfaces.

System 7 may include an independent power supply or may be powered by commercial ice making machine 1. If system 7 is powered by commercial ice making machine, input module 19 can be configured to interact with the power supply of ice making machine 1. Ice making machine 1 may already have enough excess power to supply system 7 with power or may need to incorporate additional supply or voltage outputs. Any impact on ice making machine 1 in terms of overall redesign and cost increase are minor.

Typically, laser 11 generates a large amount of heat. Therefore, laser ice etching system 7 includes the capability to either water-cool or air-cool laser 11. If laser ice etching system 7 requires water cooling, input module 19 is configured to provide coolant water to laser 11 and output module 21 is designed to remove used coolant water. Since ice making machine 1 by its nature has a chiller with cold water available, input module 19 causes a small amount of the already cold water to be diverted to cool laser 7. Such a process may require a slightly larger chiller unit for an equivalently sized ice machine but the impact on the overall ice making machine 1 design and associated cost increase will be minor.

Input module 19 and output module 21 will also include relay interfaces to sense and control functions of ice making machine 1. For example, system 7 needs to know when cycles are starting and ending so that it is able to interrupt the water flowing across vertical cold plate 3 for etching, and then restart the water flow when the etching process is completed. Each of these functions can be accomplished by having input module 19 and output module 21 interact directly with the microcontroller of ice making machine 1 or with simple relays.

While several examples of input module 19 and output module 21 functionalities were provided above, this is not to be construed as limiting the present invention as a variety of other functions for input module 19 and output module 21 have been envisioned.

User interface 17 allows a user to input the image that will be etched into the ice. User interface 17 includes both hardware and software and may be implemented in a number of different ways. Examples include, but are not limited to, a USB port on the front of the machine or a wireless network device incorporated into ice making machine 1. If user interface 17 is, for example, a USB port on the front of ice making machine 1, then the user can load PC software to create a bitmap image that will be etched onto the ice. The user then downloads the image to a small USB memory device. When the memory device is plugged into ice making machine 1 it automatically updates the image for etching. If user interface 17 is, for example, a wireless network port in the device, then the image etched is a “real-time” image obtained from PC based software. Hundreds of images could be stored and etched in pre-programmed sequences or etched randomly. The image will be changed instantly on the fly to dozens or hundreds of ice machines on the wireless network.

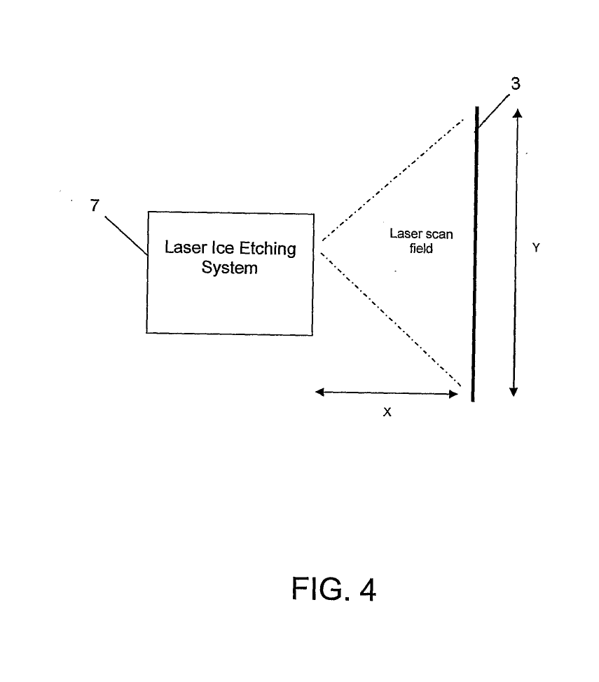

With reference to FIG. 4 and with continuing reference to FIG. 3, laser ice etching system 3 is mounted a predetermined distance in front of vertical cold plate 3 of a commercial ice making machine 1. Laser ice etching system 7 must be mounted a suitable distance from vertical cold plate 3 to allow laser aiming system 13 to sequentially aim and direct the laser beam onto each of the forming ice cubes 5. Laser ice etching system 7 may be mounted from about 4 inches to about 8 inches, for example about 6 inches, away from vertical cold plate 3 of ice making machine 1.

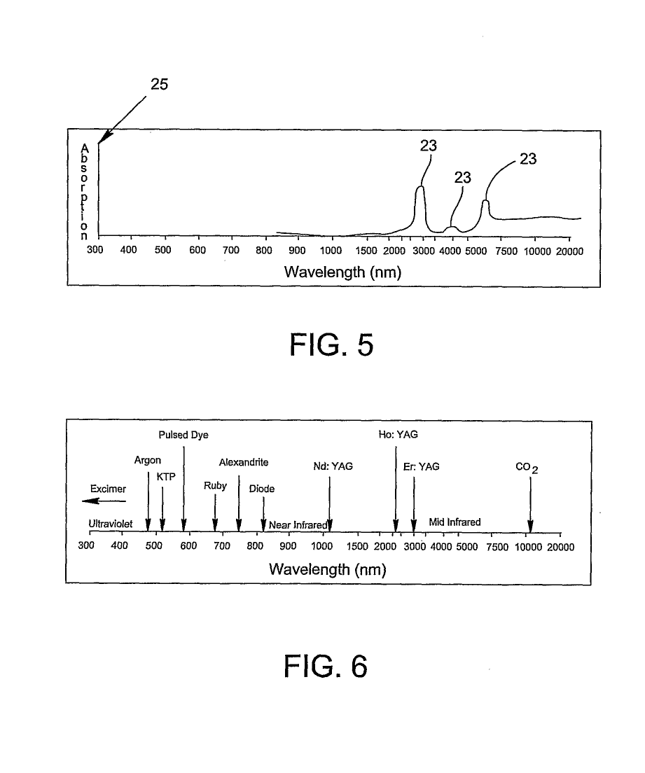

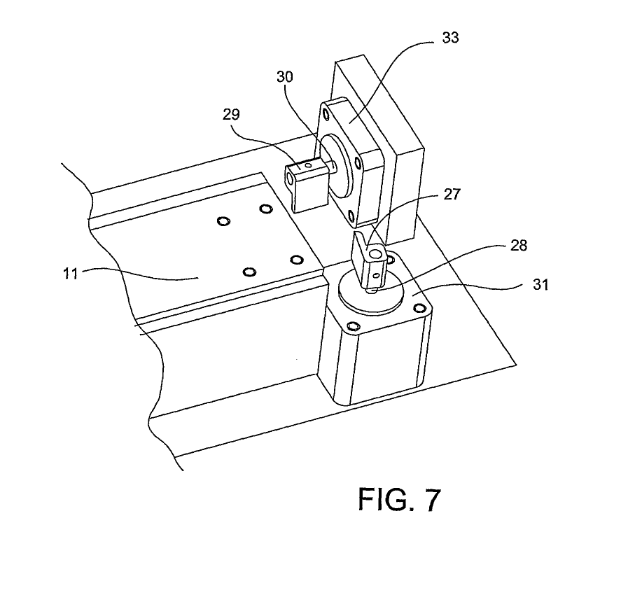

With reference to FIGS. 5 and 6, laser 11 may be any suitable laser that meets the absorption and power requirements of the present invention. There are a variety of different types, classes and subclasses of lasers. One way to classify lasers is by the material used to generate the “laser beam”. Some common materials are Eximer, Argon, KTP, Carbon Dioxide (CO2), Krypton Fluoride, Xenon Chloride, Xenon Fluoride, Argon, Helium Neon, Neodynmium:YAG, Erbium Glass, Erbium:YAG, Holmium:YAG, Ruby (Chromium Sapphire), Gallium Arsenide and many others. Each laser type creates a laser with vastly different beam properties. An important difference between each of the different lasers is the wavelength of the output light. When light hits various substances it is either, reflected, absorbed or passes through the substance. The most important design criteria in choosing laser 11 for use in system 7 is the absorption wavelength of laser energy by H₂O ice. A diagram of the absorption of H₂O ice is shown in FIG. 5. As can be seen in the figure, water absorbs some laser power at all wavelengths above approximately 1000 nm. However, there are a few “spikes” 23 where water absorbs a much higher percentage of applied power. The Y-axis 25 is a logarithmic scale so the “spikes” 23 represent a large difference in overall absorption at specific wavelengths. This information was used to select a proper laser 11 for system 7 based on the wavelength.

Laser 11 is desirably a CO₂ laser or an Erbium:YAG (Er:Yag) laser. A CO₂ laser is one of the most common of laser types and is used extensively in manufacturing and many other industries. As shown in FIG. 6, a CO₂ laser has a wavelength of approximately 10,600 nm. Er:YAG lasers are widely used in the medical sector. Since this type of laser pinpoints the maximum absorption spike of H₂O, they are ideal for surgical, skin, and dental applications. Also, it is possible to manufacture very small and compact Er:YAG lasers. One of the drawbacks of this type of laser is that it is very expensive. As can be seen in FIG. 4, Er:YAG lasers have a wavelength of approximately 2,940 nm. At this wavelength the absorption coefficient of water (H₂O) is about 12,700 cm-1.

Both the CO₂ laser and the Er:Yag laser provide explosive vaporization during interaction with ice. Explosive vaporization occurs when ice changes almost instantly to vapor instead of melting to water. This process is critical to the present invention. If the etching process changes the ice to water it marks the ice, but then when the ice formation continues, the etched void fills back in with new clear ice and leaves very little marking. However, with explosive vaporization every laser pulse results is a clearly visible white mark inside the cube which remains very visible and permanent even when fresh clear ice is layered on top of the etching.

While only CO2 lasers and Er:YAG lasers were discussed in detail above, this is not to be construed as limiting the present invention as any suitable laser may be used in system 7.

With reference to FIG. 7, and with continuing reference to FIG. 3, laser aiming system 13 comprises multiple mirrors that have precisely controlled rotation. Typically, laser aiming system 13 includes a first mirror 27 positioned at a 90° angle from a second mirror 29. First mirror 27 controls X-axis positioning and second mirror 29 controls Y-axis positioning. Often there is a third mirror (not shown) that is used as a shutter to direct the laser beam completely away from the target area. First mirror 27 is coupled to a first drive device 31 via a shaft 28 and second mirror is coupled to a second drive device 33 via a shaft 30. First drive device 31 and second drive device 33 are under the command of controller 9.

Depending on the type of laser used, two different drive devices may be used as first drive device 31 and second drive device 33. If the laser implements a continuous beam, then a servo-galvanometer drive device will be used. On the other hand, if the laser implements a pulsed beam, a stepper motor drive device will be used.

The servo galvanometer approach draws a vector image of continuous lines on the ice cube and is advantageous if a continuous wave laser is implemented. The stepper motor approach draws a bitmap image of dots on the ice and would is advantageous if a pulsed laser is implemented. Each of these systems will be described in greater detail below.

If a pulsed laser is implemented as laser 11, then laser aiming system 13 should be implemented using stepper motors as first drive device 31 and second drive device 33 to rotate the first mirror 27 and second mirror 29. In a pulsed laser the beam is not continuous; instead the output is short pulses of energy. Stepper motors rotate in steps. The design of the motor determines the size of the steps. The size of the steps of such stepper motors can range from about 0.9° to about 90°. For use in laser aiming system 13, the stepper motor should have a step size that is as small as possible so that system 3 can etch an image with as much detail as possible.

On the other hand servo-galvanometer drive devices are commonly used in laser aiming systems in manufacturing for etching and marking applications and also for laser light shows. The servo-galvanometer aiming system works as follows: analog signals from a controller are sent to the servo-galvanometer, which has a continuous range of motion and smoothly deflects from a zero position based on the input it sees. This system is ideal when coupled with a continuous wave laser because the laser beam is continuous and the mirror positioning is continuous. The end result is a beam that smoothly moves and draws continuous lines in whatever shape is programmed into the controller. This positioning system is desirable in the present invention if a continuous wave laser is implemented as laser 11.

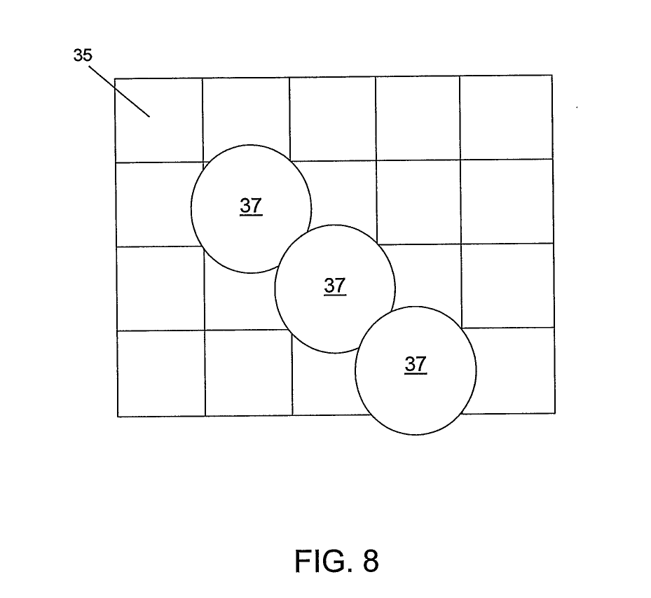

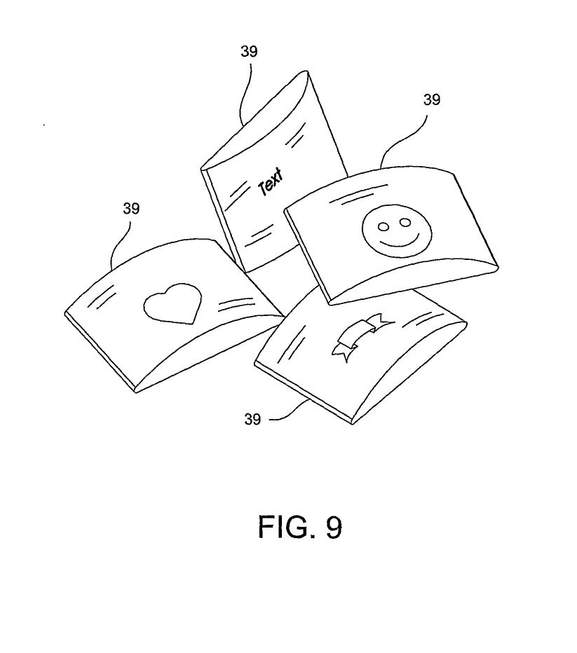

With reference to FIG. 8, and with continuing reference to FIG. 2, assuming that system 7 utilizes a pulsed laser as laser 11 and 0.9° stepper motors as drive devices 31 and 33 in laser aiming system 13, the 0.9° stepper motors will be controlled by controller 9 with a positioning system called “micro-stepping”. This positioning system allows the motors to be positioned in quarter steps or less. A quarter step of a 0.9° stepper motor is equal to 0.225°. With knowledge of this information, the greatest bitmap resolution of an image on each ice cube can be determined. The average ice cube produced by a prior art commercial ice machine is about one inch by one inch. In order to easily incorporate system 3 into prior art commercial ice making machines 1 with only minor design modifications, the distance from laser aiming system 13 of system 7 to vertical cold plate 3 is about 6 inches. Such a positioning of system 7 calculates to about 400 pixels across the entire vertical cold plate 3 of approximately 12 inches and approximately 10 cubes. As shown in FIG. 8, the 400×400 pixel bitmap on vertical cold plate 3 means each pixel 35 is approximately 0.03 inches or ¾ mm. Given a certain amount of unusable space at the edges and between cubes, a maximum bitmap on each cube is about 35×35 pixels. This works well with the controllable laser beam explosive vaporization spot 37, which has a size of about 1 mm. Therefore, there will be adequate coverage on the ice cube and slight overlap of each explosive vaporization spot 37 etched by the beam. A design, graphic, text, logo or shape is formed after each dot has been etched into the ice cube.

The above discussion is meant for illustration purposes only and all of the above dimensions may be changed based on a variety of factors. Therefore, the present invention is not limited to the above-described dimensions and measurements.

With reference to FIG. 9, an ice cube can be laser etched with any design that has been entered into system 7 via user interface 17 to produce a laser etched ice cube 39. The design may include, but is not limited to, a company logo, text, a clipart image, or the like. As can be seen in the figure, the laser etched image appears to be “floating” inside the ice cube.

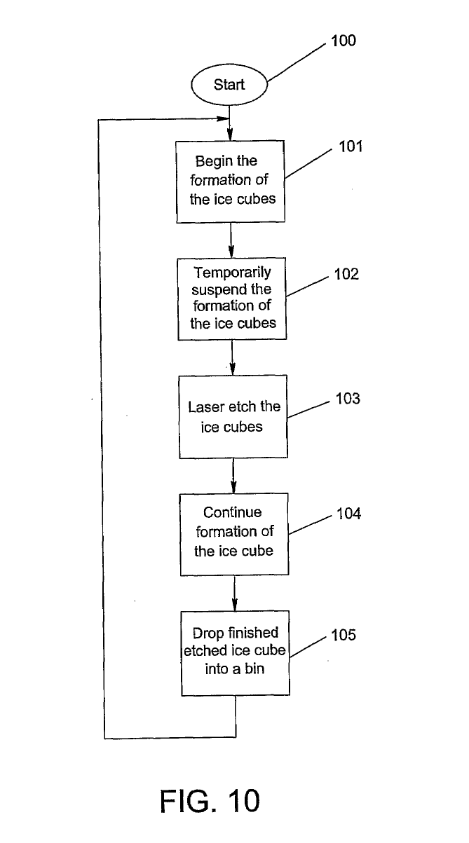

With reference to FIG. 10, the present invention is also a method for laser etching an ice cube. The method begins at start 100 and proceeds to step 101 wherein the formation of the ice cubes on vertical cold plate 3 of commercial ice making machine 1 is started by providing a stream of water from the top down across vertical cold plate 3. Next, at step 102, the formation of the ice cubes is temporarily suspended by controller 9 by implementing a command to stop the water flow across vertical cold plate 3. Then, at step 103, a laser beam is aimed and directed towards vertical cold plate 3 to “laser etch” the ice cubes with a programmed design or designs. Then, after laser etching is complete, at step 104, the formation of the ice cubes is continued by controller 9 so that the resulting etched image ends up “inside” the cube. The finished, laser-etched ice cubes are then released from vertical cold plate 3 into a bin at step 105 and the method is repeated. The temporary suspension of the formation of the ice cubes allows the image to be accurately “etched” into the ice and the following continued formation of the ice cubes seals the image within the ice cube providing the visual effect that the image is floating within the ice cube.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A laser ice etching system comprising:
a laser for producing a laser beam;
a laser aiming system adapted to aim and direct a laser beam produced by the laser onto forming ice cubes; and
a controller operatively coupled to the laser and the laser aiming system, the controller providing commands to the laser to produce the laser beam and commands to the laser aiming system to aim and direct the laser beam onto the forming ice cubes,
wherein the laser ice etching system is positioned adjacent to a vertical cold plate of an ice making machine and forms an image in the center of an ice cube by aiming and directing the laser beam in a predetermined pattern over a portion of the ice cube.

2. The laser ice etching system of claim 1, further comprising a user interface operatively coupled to the controller and adapted to provide input from a user to the controller.

3. The laser ice etching system of claim 2, wherein the user interface is a USB port, a wireless network device, a CD-ROM drive or any combination thereof.

4. The laser ice etching system of claim 2, wherein the input from the user is a programmed design.

5. The laser ice etching system of claim 1, further comprising a lens positioned to focus the laser beam onto the vertical cold plate of the ice making machine.

6. The laser ice etching system of claim 1, wherein the laser aiming system comprises a first mirror operatively coupled to a first drive device and a second mirror operatively coupled to a second drive device.

7. The laser ice etching system of claim 6, wherein the first drive device and the second drive device are stepper motors.

8. The laser ice etching system of claim 6, wherein the first drive device and the second drive device are servo-galvanometers.

9. The laser ice etching system of claim 1, wherein the laser is one of a CO₂ laser and an Er:YAG laser.

10. The laser ice etching system of claim 1, wherein explosive vaporization occurs when the laser beam contacts the ice cube causing the ice to change immediately to vapor thereby creating a white mark on the ice cube.

11. A method of laser etching an ice cube comprising the steps of:
a) forming a plurality of ice cubes on a vertical cold plate of an ice making machine by providing a stream of water across the vertical cold plate;
b) temporarily suspending the stream of water across the vertical cold plate thereby stopping formation of the plurality of ice cubes;
c) aiming and directing a laser beam towards the vertical cold plate to sequentially etch each of the plurality of ice cubes with at least one programmed design to produce an etched image on each of the plurality ice cube; and
d) continuing the stream of water across the vertical cold plate thereby resuming formation of the ice cube.

12. The method of claim 11, wherein the laser beam is produced by one of a CO₂ laser and an Er:YAG laser.

13. The method of claim 11, wherein the at least one programmed design is input by a user via a user interface.

14. The method of claim 13, wherein the user interface is a USB port, a wireless network device, a CD-ROM drive or any combination thereof.

15. The method of claim 14, wherein the step of aiming and directing the laser beam is performed by a laser aiming system.

16. The method of claim 15, wherein the laser aiming system comprises a first mirror operatively coupled to a first drive device and a second mirror operatively coupled to a second drive device.

17. The method of claim 16, wherein the first drive device and the second drive device are stepper motors.

18. The method of claim 16, wherein the first drive device and the second drive device are servo-galvanometers.

19. An ice cube formed pursuant to the method of claim 11.

20. A method of forming an image on an ice cube comprising the step of:
aiming and directing a laser beam on a surface of an ice cube in a predetermined pattern.
